(19) United States
(12) Patent Application Publication
(10) Pub. No.: US 2008/0314525 A1
(43) Pub. Date: Dec. 25, 2008

(54) Web lamination system

(75) Inventors: Dana R. Hanson, West Chicago, IL (US); James E. Johnson, Geneva, IL (US); Mitch L. Gritzner, Montgomery, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Processing Technologies, LLC.

(21) Appl. No.: 11/821,298

(22) Filed: Jun. 22, 2007

(51) Int. Cl. B29B 15/00

(52) U.S. Cl. 156/501; 156/536

(57) ABSTRACT

An extrusion system is provided. The extrusion system includes a first extrusion assembly and a second extrusion assembly. The first extrusion assembly is configured to continuously form a first extruded web while the second extrusion assembly is configured to continuously extrude a second extruded web. The first and second extrusion assemblies are also configured to cooperate so that the first extruded web is capable of moving in an assembly path wherein the first extruded web can be joined with the second extruded web to thereby continuously form a composite web made of the first and second joined webs.

### TECHNICAL FIELD OF THE INVENTION

This invention pertains to systems for extruding webs, and in more particular applications, to systems for extruding multiple webs for lamination to one another.

### BACKGROUND OF THE INVENTION

Extrusion systems generally extrude one or more molten polymer webs and/or coatings for use in a variety of products, such as automotive components. Oftentimes, extrusion processes are performed at one machine, are wound into a coil and then processed separately at another machine. For example, extruded material having a base body may be extruded at one machine, wound up and then unwound at another machine for combination with additional webs and/or coatings. This type of process is performed to permit a variety of combinations of extruded materials. For example, it may be desired to produce a multi-layer product having one type of optical finish but later may be desired to have an alternative finish. In this manner, the base extruded layer can be wound and then sent to either of the finishing machines for application of the appropriate finish. Therefore, having multiple separate operations permits a variety of different products to be produced from the same extruded materials. However, with this type of manufacturing, multiple machines are required to produce the various products and therefore, the extra machines may take up necessary floor space. Therefore, in some instances, it may be more economical to have continuously extruded materials that can be combined without being wound and then unwound at additional machines. In some instances, a continuous process may save time, manpower, money and floor space.

Furthermore, conventional processes often extrude a base layer or substrate to which additional layers are coated. For example, a base polymer layer may be extruded and subsequent coating layers, such as a color coating and an outer optical finish coating may be extruded and applied thereto. However, the coating layers, as opposed to webs, are not sufficiently rigid to be self-supporting and therefore generally must be directly coated onto a substrate. In this manner, multiple coatings are often applied, each performing a specific function(s), such as adding color or an optical finish, for the final product. Therefore, oftentimes multiple extrusion coatings must be applied, thereby increasing the complexity of the overall system.

### SUMMARY OF THE INVENTION

In one form, an extrusion system is provided. The system includes a first extrusion assembly and a second extrusion assembly. The first extrusion assembly is configured to continuously form a first extruded web and the second extrusion assembly is configured to continuously form a second extruded web. The first and second extrusion assemblies are configured to cooperate so that the first extruded web is capable of moving in an assembly path wherein the first extruded web can be joined with the second extruded web to thereby continuously form a composite web consisting of the first and second joined webs.

According to one form, the first extrusion assembly comprises a first roll stack having a plurality of rollers and the second extrusion assembly comprises a second roll stack having a plurality of rollers.

According to one form, the system is in combination with the first and second extruded webs wherein the first extruded web passes through the first roll stack and the second extruded web passes through at least two of the plurality of rollers of the second roll stack prior to being joined with the first extruded web.

In one form, the system is in combination with the first and second extruded webs wherein the first extruded web passes through the first roll stack and the second extruded web is joined with the first extruded web prior to passing through the second roll stack.

According to one form, the system further includes an outlet to output a product.

In one form, the system is in combination with the first and second extruded webs wherein the first and second roll stacks are selectively configurable between: (a) a first configuration wherein the first extruded web is joined with the second extruded web; (b) a second configuration wherein the first extruded web passes through at least one of the first and second roll stacks to the outlet without being joined to the second extruded web; and (c) a third configuration wherein the second extruded web passes through the second roll stack and to the outlet without being joined to the first extruded web.

In one form, at least one roller in at least one of the first and second roll stacks is a conditioning roller.

According to one form, the first extrusion assembly comprises a first extruder and the second extrusion assembly comprises a second extruder.

In one form, the first extruder continuously forms the first extruded web that moves in a predetermined assembly path in a first direction and the second extruder continuously forms the second extruded web that moves in a predetermined assembly path in a second direction, the second direction being substantially opposite the first direction.

According to one form, the system is in combination with at least one of the first and second webs wherein at least one of the first and second extruders is capable of forming a web comprising multiple layers of material.

In one form, the first and second extrusion assemblies are movable selectively towards and away from each other.

Other objects, features, and advantages of the invention will become apparent from a review of the entire specification, including the appended claims and drawings.

### BRIEF DESCRIPTION OF THE DRAWINGS

FIG. 1 is a somewhat diagrammatic representation of the configuration of an extrusion system producing a composite web;

FIG. 2 is a somewhat diagrammatic representation of the configuration of an extrusion system producing a first web;

FIG. 3 is a somewhat diagrammatic representation of the configuration of an extrusion system producing a second web;

FIG. 4 is a perspective view of an extrusion system prior to extruding webs;

FIG. 5 is a perspective view of an extrusion system laminating a first and a second web;

FIG. 6 is an alternative perspective view of the extrusion system of FIG. 5;

FIG. 7 is a perspective view of another embodiment of an extrusion system laminating a first and a second web;

FIG. 8 is an alternative perspective view of the extrusion system of FIG. 7;

FIG. 9 is a perspective view of yet another embodiment of an extrusion system laminating a first and a second web;

FIG. 10 a perspective view of an extrusion system outputting a single non-laminated web; and

FIG. 11 is an alternative perspective view of the extrusion system of FIG. 10.

### DETAILED DESCRIPTION OF THE ILLUSTRATED EMBODIMENT

In FIG. 1, an extrusion system 20 is shown. The extrusion system 20 includes a first extrusion assembly 22 and a second extrusion assembly 24. The first extrusion assembly 22 is configured to continuously form a first extruded web 26 consisting of one or more component layers while the second extrusion assembly is configured to continuously form a second extruded web 28 consisting likewise of one or more component layers. The first and second extrusion assemblies 22,24 are configured to cooperate so that the first extruded web 26 is capable of moving in a predetermined assembly path to a location at 30 whereat the first extruded web 26 can be joined with the second extruded web 28 to thereby continuously form a composite web 32.

The system 20 can also be configured as shown in FIG. 2. In this configuration, the first extruded web 26 is not joined with the second extruded web 28, but instead is processed in the system 20 and output to a collection location 34, at which it is staged for: a) preparation as an end product; or b) further processing.

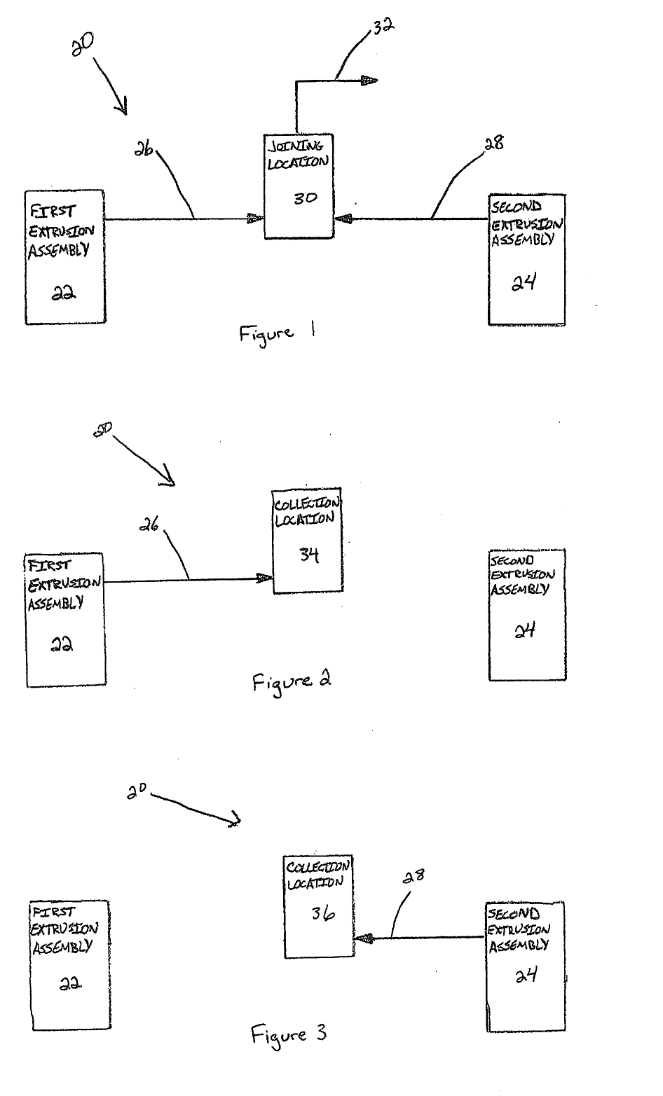

Additionally, the system 20 can be configured as shown in FIG. 3. In this configuration, the second extruded web 28 is not joined with the first web 26, but instead is processed in the system 20 and output to a collection location 36, at which it is similarly staged for: a) preparation as an end product; or b) further processing.

In the configuration shown in FIG. 2, the second extruded web 28 may not be formed simultaneously with the first extruded web 26, or alternatively, may be extruded and used elsewhere in, or outside of, the system 20. Similarly, in the configuration shown in FIG. 3, the first extruded web 26 may not be formed simultaneously with the second extruded web 28, or alternatively, may be extruded and used elsewhere in, or outside of, the system 20.

The nature of the components making up the first and second extruded webs 26,28 is not critical to the present invention. Virtually any components conventionally used to form discrete webs that might be pre-formed and joined are contemplated. The first extruded web 26 may pass through the second extrusion assembly 24 in traveling to the joining location 30 and collection location 34 or follow a different path thereto. Likewise the second extruded web 28 may pass through the first extrusion assembly 22 in traveling to the joining location 30 and collection location 36 or follow a different path thereto.

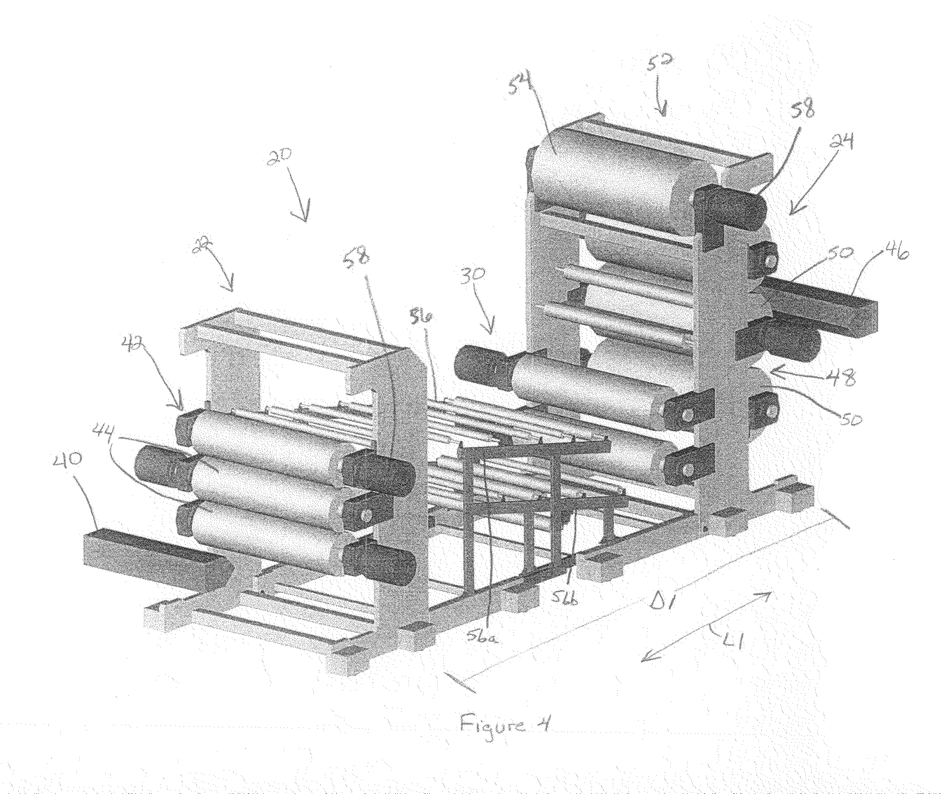

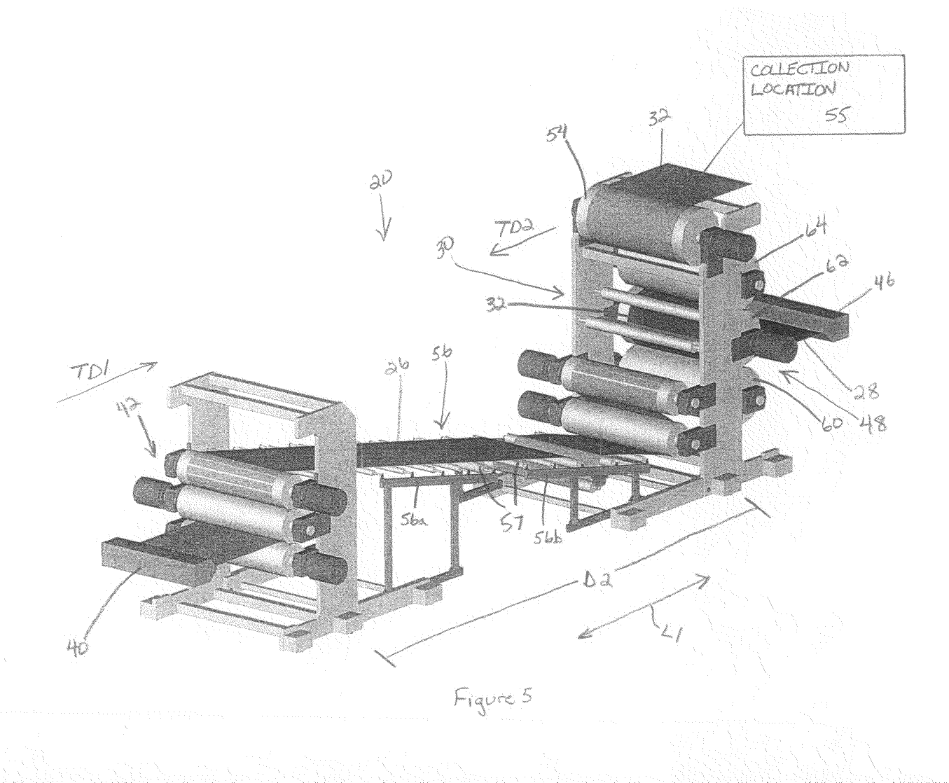

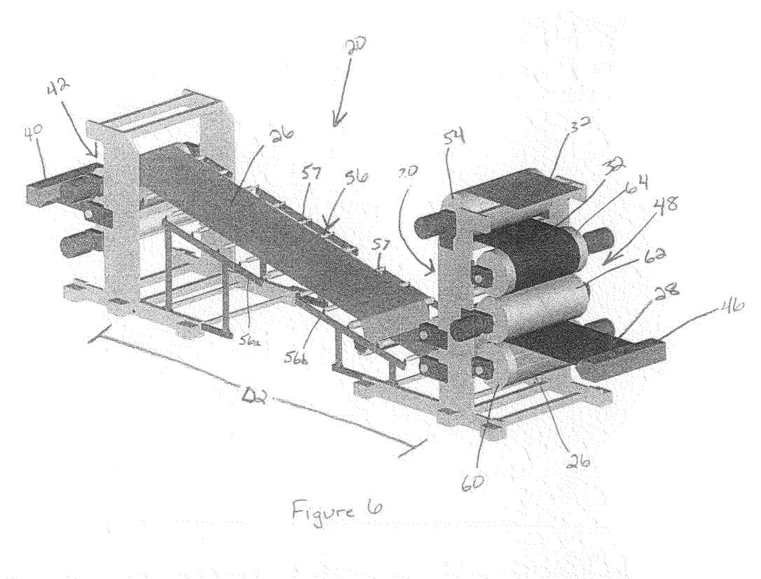

Specific exemplary configurations and embodiments of the extrusion system 20 will now be discussed in more detail with reference to FIGS. 4-11. In FIG. 4, the system 20 is illustrated preparatory to extruding the first and second extruded webs 26,28. It should be noted that in this configuration the first extrusion assembly 22 is spaced from the second extrusion assembly 24, in a direction of the double-headed line L1, a distance D1. The first extrusion assembly 22 includes an extruder 40 and a roll stack 42. The roll stack 42 includes a plurality of rollers 44, described below. The second extrusion assembly 24 also includes an extruder 46 and a roll stack 48. The roll stack 48 includes a plurality of rollers 50, also described below. It should be understood that each of the extruders 40,46 may include multiple extruders which combine at a common die to form each of the first and second extruded webs 26,28.

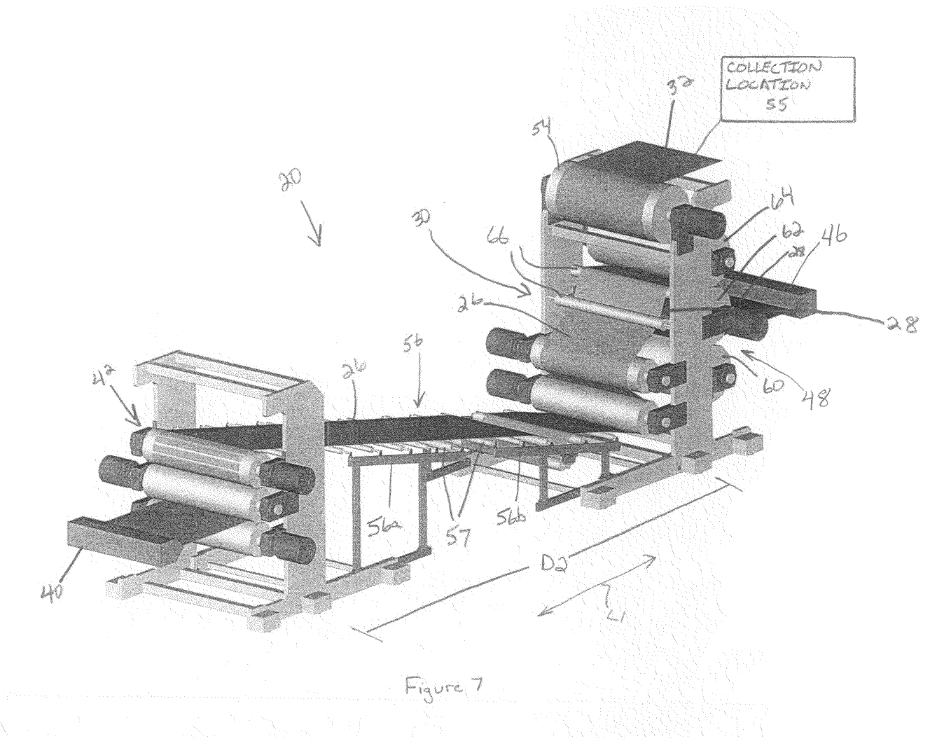

In one form, the extruder 40 continuously extrudes the first extruded web 26 that travels in a first direction, as indicated by the arrow TD1 in FIG. 5, in a predetermined path. The extruder 46 continuously extrudes the second extruded web 28 that travels in a second direction, as indicated by the arrow TD2 in FIG. 5, which is substantially opposite the direction TD1. By orienting and positioning the extruders 40,46 as shown in FIG. 4, the overall footprint of the system 20 is minimized. Specifically, the location and orientation of the extruders 40,46 permit the first and second webs 26,28 to travel in substantially opposite directions TD1 and TD2 towards one another to be combined wherein the resulting composite web 32 can continuously move out of the system 20.

The rollers 44,50 can include a variety of rollers such as drive rollers, idler rollers, conditioning rollers, nip rollers and the like, as understood by those skilled in the art. Such rollers and other extrusion components are discussed in U.S. Pat. No. 7,165,962, which is incorporated herein by reference. For example, in one embodiment, at least one of the plurality of rollers 44 is a conditioning roller to thereby cool the first extruded web 26 and at least one of the plurality of rollers 50 is a different conditioning roller to heat the second extruded web 28 in preparation for lamination to the first extruded web 26. It should be understood by those skilled in the art that other forms of conditioning rollers may also be included in the system 20. Furthermore, it should be understood that additional methods of heating and cooling the webs 26,28 may also be utilized.

In the embodiment of FIGS. 5-6, the joining location 30 is at the second extrusion assembly 24, and more specifically, the roll stack 48. However, as discussed above, the joining location 30 may be located at the first extrusion assembly 22 or elsewhere in the system 20. The resulting composite web 32 exits the system 20 at an outlet location 52, as by passing over an outlet roller 54 to a collection location 55.

Furthermore, the system 20 may include a conveyor section 56 having idler rollers 57 to help convey the webs 26,28 in a region between the roll stacks 42,48. Additionally, the system 20 may include motors 58 for driving the rollers 44,50, thereby to convey the first and second extruded webs 26,28 through the system 20.

It should be noted that the first extrusion assembly 22 is spaced from the second extrusion assembly 24 by a distance, represented by D2, which is greater than D1. Comparing FIGS. 4 and 5, it can be seen that the conveyor section 56 may be effectively lengthened and shortened, along the line L1, by moving the extrusion assemblies 22,24 selectively towards and away from each other along the line L1. For example, when the system 20 is not running, the conveyor system 56 may be shortened to minimize the overall footprint of the system 20, such as shown in FIG. 4. The conveyor section 56 may also be shortened for initial system startup or when otherwise desired to shorten the distance between the extrusion assemblies 22,24.

Referring to FIGS. 5-6, one configuration of the system 20 is shown whereby the first extruded web 26 and the second extruded web 28 are joined together, such as through lamination, to form the composite web 32. This system configuration is represented diagrammatically in FIG. 1. The first extruded web 26 moves in a predetermined assembly path wherein it passes through the roll stack 42 and is supported and guided between the roll stacks 42,48. In this configuration, the first extruded web 26 passes partially around roller 60 and is joined with the second extruded web 28 before passing between roller 60 and roller 62 to form the composite web 32. The composite web 32 continues partially around roller 64 and roller 54, finally exiting the system 20 for delivery to the collection location 55. The rollers 60,62,64 laminate the first and second extruded webs 26,28 to thereby form the composite web 32.

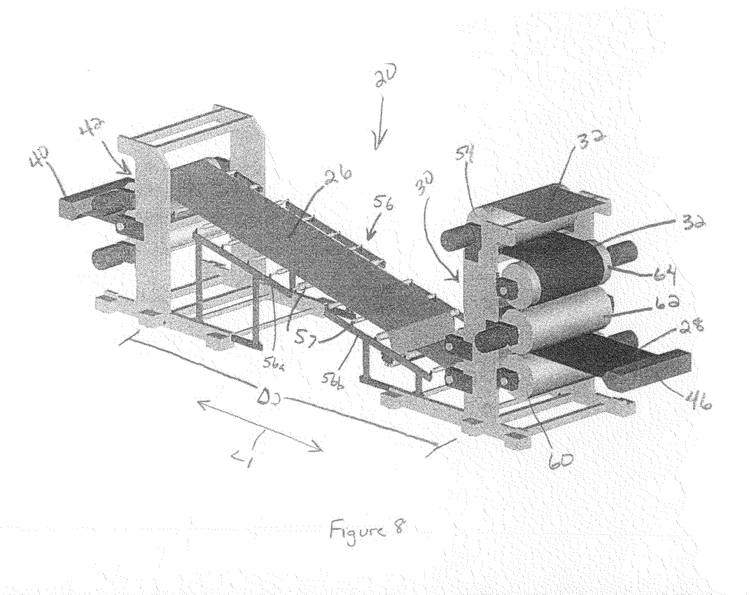

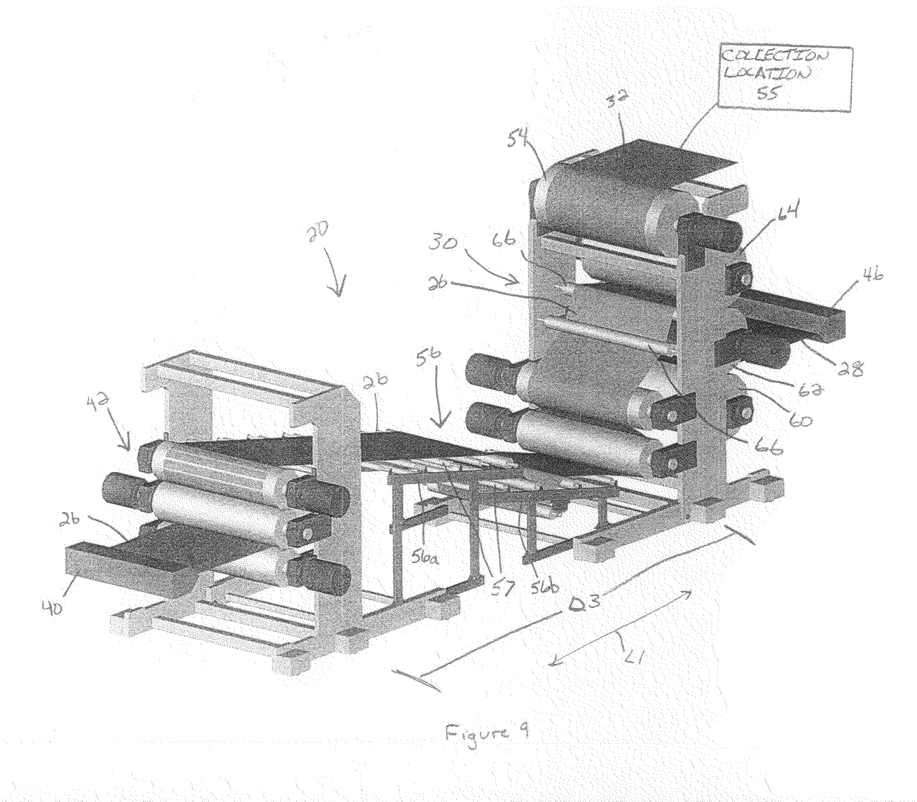

Referring now to FIGS. 7-8, an alternative system configuration is shown whereby the first extruded web 26 and the second extruded web 28 are joined together, such as through lamination. This configuration is also represented diagrammatically in FIG. 1. It should be noted that the first extrusion assembly 22 is separated from the second extrusion assembly by the distance D2. The first extruded web 26 passes through the roll stack 42, through the conveyor section 56 and through guide rollers 66. In this configuration, the second extruded web 28 passes between roller 60 and roller 62 before being joined with the first extruded web 26 to form the composite web 32. The composite web 32 continues partially around roller 64 and roller 54, finally exiting the system 20.

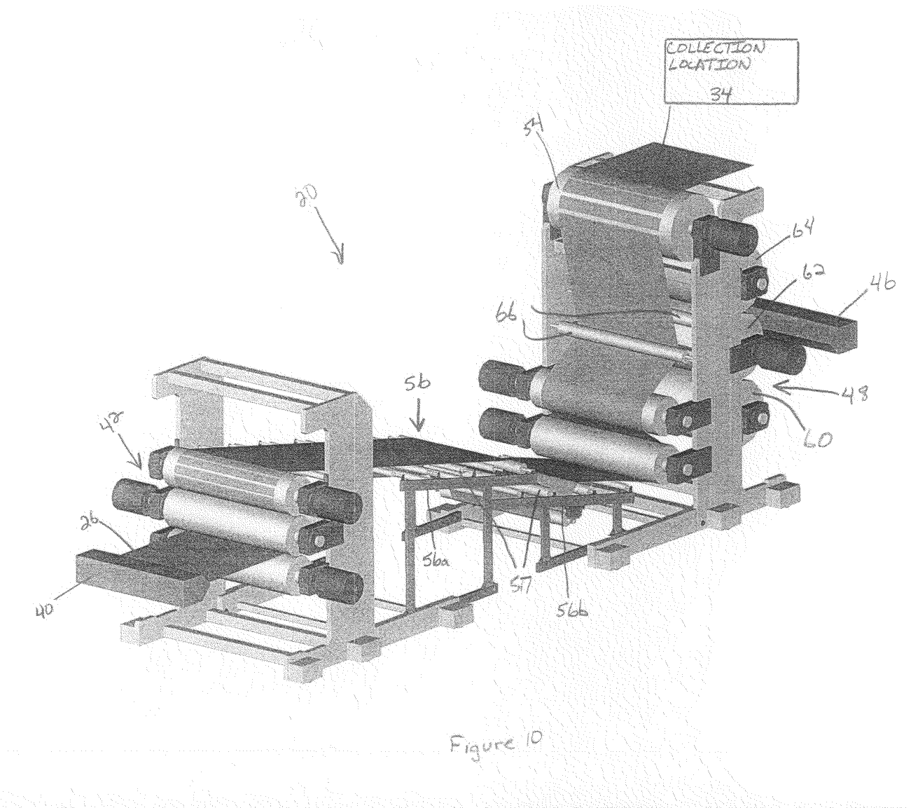

Yet another configuration is illustrated in FIG. 9. This configuration is substantially similar to the configuration illustrated in FIGS. 7-8. The main difference is the distance between the first and second extrusion assemblies 22,24, represented by D3, which is smaller than the distance D2. As described above, by moving the extrusion assemblies 22,24 towards each other, separate conveyor section components 56a,56b, respectively on the first and second extrusion assemblies 22,24, overlap along the line L1. This telescoping feature may be used for a variety of purposes, such as during system startup to provide a shorter or longer distance between the first and second extrusion assemblies 22,24. However, it should be understood that the system 20 may be configured similarly to the embodiment shown in FIGS. 5-6 whereby the first web 26 is joined to the second web 28 prior to passing between rollers 60,62 while still maintaining the distance between the first and second extrusion assemblies 22,24, as shown in FIG. 9.

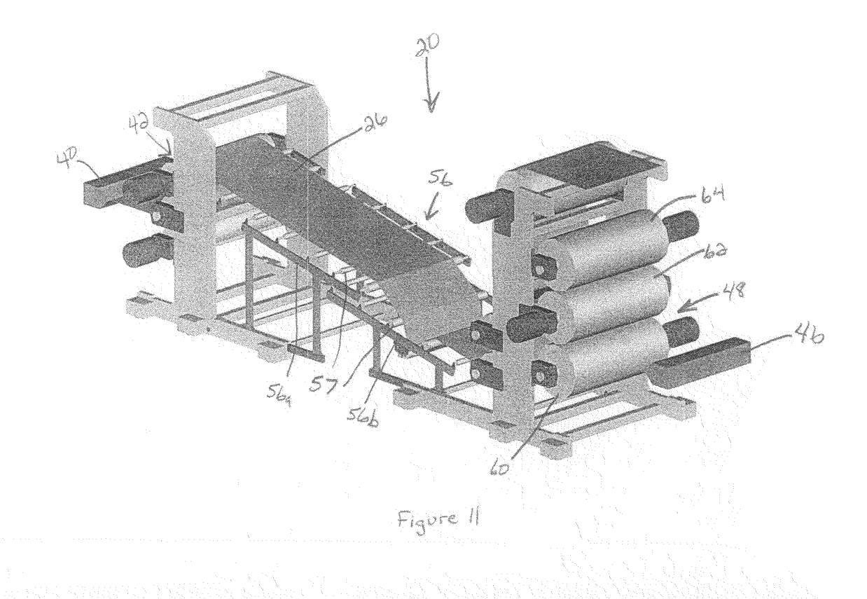

A further configuration is shown in the embodiment in FIGS. 10-11. This system configuration is also represented diagrammatically in FIG. 2. In this form, the first extruded web 26 passes through the system 20 without being joined with the second extruded web 28. In one form, the extruder 46 does not extrude the second extruded web 28. In another form, the extruder 46 does extrude the second extruded web 28, but the second extruded web 28 is not joined with the first extruded web 26 and instead passes to another part of the system 20 or out of the system 20. As seen in FIG. 10, the first extruded web 26 does not pass through the roll stack 48, but instead simply passes over the roller 54, finally exiting the system 20 to the collection location 34. However, it should be understood that the first extruded web 26 may also pass through the roll stack 48, such as by passing over at least one of the rollers 60,62,64, if desired. These rollers 60,62,64 may provide further processing/conditioning, such as cooling, for the first extruded web 26.

Similarly, the second extruded web 28 may pass through the system 20 in a predetermined assembly path without being combined with the first extruded web 26. This system configuration is represented diagrammatically in FIG. 3. In this form, the extruder 40 may or may not extrude the first extruded web 26 for use in another part of the system 20 or outside of the system 20. The second extruded web 28 passes through the roll stack 48, such as through rollers 60,62,64, finally exiting the system 20, passing over roller 54 to the collection location 36. Alternatively, the second extruded web 28 could also pass through the roll stack 42 prior to exiting the system.

It should be noted that the first and second extruded webs 26,28 are distinguishable from coatings, as understood by those skilled in the art, which are in a state that is eventually transitioned into a layer/web. For example, the first and second extruded webs 26,28 have sufficient thickness and rigidity such that they need not be coated onto a substrate for processing in the system 20. A variety of materials may be used as the first and second extruded webs 26,28. For example, various forms of polymers may be extruded to form the first and second webs 26,28 as understood by those skilled in the art. Furthermore, either or both of the first and second webs 26,28 may be coextruded webs comprising a plurality of materials and/or layers. For example, the extruder 40 may be suitable for extruding the first extruded web 26 which has a variety of layers, such as a base layer, a color layer and an outer optical finish layer, all in a single coextruded web. As processed in the system 20, the first extruded web 26 can be maintained having an upward orientation throughout the system 20 (in the various configurations described herein) such that the outer optical layer is maintained having an upward orientation and is not prone to becoming damaged in the system 20.

It should be appreciated that for all of the disclosed embodiments there are many possible modifications. Additionally, it should be understood that the embodiments described herein may be utilized with a variety of additional optional components understood by those skilled in the art.

1. An extrusion system comprising:
a first extrusion assembly configured to continuously form a first extruded web; and
a second extrusion assembly configured to continuously form a second extruded web,
the first and second extrusion assemblies configured to cooperate so that the first extruded web is capable of moving in an assembly path wherein the first extruded web can be joined with the second extruded web to thereby continuously form a composite web made of the first and second joined webs.

2. The extrusion system of claim 1 wherein the first extrusion assembly comprises a first roll stack having a plurality of rollers and the second extrusion assembly comprises a second roll stack having a plurality of rollers.

3. The extrusion system of claim 2 in combination with the first and second extruded webs wherein the first extruded web passes through the first roll stack and the second extruded web passes through at least two of the plurality of rollers of the second roll stack prior to being joined with the first extruded web.

4. The extrusion system of claim 2 in combination with the first and second extruded webs wherein the first extruded web passes through the first roll stack and the second extruded web is joined with the first extruded web prior to passing through the second roll stack.

5. The extrusion system of claim 2 further comprising an outlet to output a product.

6. The extrusion system of claim 5 in combination with the first and second extruded webs wherein the first and second roll stacks are selectively configurable between: (a) a first configuration wherein the first extruded web is joined with the second extruded web; (b) a second configuration wherein the first extruded web passes through at least one of the first and second roll stacks to the outlet without being joined to the second extruded web; and (c) a third configuration wherein the second extruded web passes through the second roll stack and to the outlet without being joined to the first extruded web.

7. The extrusion system of claim 2 wherein at least one roller in at least one of the first and second roll stacks is a conditioning roller.

8. The extrusion system of claim 1 wherein the first extrusion assembly comprises a first extruder and the second extrusion assembly comprises a second extruder.

9. The extrusion system of claim 8 wherein the first extruder continuously forms the first extruded web that moves in a predetermined assembly path in a first direction and the second extruder continuously forms the second extruded web that moves in a predetermined assembly path in a second direction, the second direction being substantially opposite the first direction.

10. The extrusion system of claim 8 in combination with at least one of the first and second extruded webs wherein at least one of the first and second extruders is capable of forming a web comprising multiple layers of material.

11. The extrusion system of claim 1 wherein the first and second extrusion assemblies are movable selectively towards and away from each other.
